(19) United States
(12) Patent Application Publication
(10) Pub. No.: US 2016/0325586 A1
(43) Pub. Date: Nov. 10, 2016

(54) Wheel Or Tire Lifter

(71) Applicant: Eian Douglas Mathieson, St Ives (AU)

(72) Inventor: Eian Douglas Mathieson, St Ives (AU)

(73) Assignees: Eian Douglas Mathieson, St Ives (AU); Professional Tool Products LLC, Travelers Rest, SC (US)

(21) Appl. No.: 15/011,079

(22) Filed: Jan. 29, 2016

(30) Foreign Application Priority Data
Dec. 3, 2014 (CN) 201420749514.2

(51) Int. Cl. B60B 29/00; B60S 5/00

(52) U.S. Cl. CPC B60B 29/001; B60B 29/002; B60S 5/00

(57) ABSTRACT

A wheel or tire lifter according to the present invention comprises a base, consisting of a base frame and a vertical strut, said base frame being provided with a rolling wheel for the base movement, a drive lift means arranged in said vertical strut; a driving means to drive said drive lift means, and a wheel or tire bracket connected with said drive lift means, on which the tire to be installed is directly placed. According to the wheel or tire lifter provided by the present invention, the tire to be installed can be put or placed on the wheel or tire bracket directly, so said wheel or tire bracket is driven by the said drive lift means and moved upward and downward to a desired height or position, and the tire can easily be moved to the wheel installation position of a car.

### TECHNICAL FIELD

The present invention relates to an equipment or device for vehicle or car repair and maintenance, particularly, a wheel and/or tire lifter for installation and disassembly of a tire.

### BACKGROUND

Wheels and tires are an important part of very car, wheels and tires need to be regularly rotated and balanced during tire repair, replacement or normal maintenance. Traditionally, the changing of tires is carried out by the technician manually, thus the wheel or tire often needs to be lifted up to a certain height, particularly if the vehicle is on a hoist or lift. This lifting, turning or carrying is an ergonomic nightmare requiring considerable physical strength. Wheels and tires are getting much larger and heavier across the world. SUVs, pickups and light trucks/delivery vans exposing technicians to a high risk off back injury. In addition, increasingly it is becoming common in many countries today to legislate to limit the amount one person can lift, this limit is generally 20-25 kgs.

Accordingly, the market has been seeking a device to limit this risk to workers during wheel or tire fitting and removal. A Chinese utility model patent publication No. CN202294070 disclosed a new high effective automatic tire installation or fix machine, relating to an equipment for car manufacture and repair, specifically to a tire installation equipment, and it comprises of fix clamp (1), wiggle rack (2), frame (3), slidable or movable wheel (4), hydraulic cylinder (5) and tire lift rack (6). Slidable or movable wheel (4) is arranged under frame (3); cylinder (5) is arranged on frame (3), and a piston bar of cylinder (5) is positioned upward. Tire lift rack (6) is located above frame (3). The piston bar of cylinder (5) is connected to the central portion of lower portion of tire lift rack (6). On the tire lift rack (6) a round tire accommodation slot (7) is provided. The lower end of wiggle rack (2) is connected to frame (3) by a hinge joint, and fix clamp (1) is connected to the upper end of wiggle rack (2). This utility model patent can solve the problems of the current tire installation machines, including complicated structure, time consuming installation and low efficiency. However, tire lift rack (6) of the automatic tire installation machine can lift a tire, but the tire needs to be taken or drawn out from accommodation slot (7) by fix clamp (1) while it reaches a certain height because the tire IS placed in accommodation slot (7), then the tire is put in the position of the car wheel by fix clamp (1), thus, it needs great effort, and is not easy to be aligned, as a result, this machine is not conveniently used.

### SUMMARY OF INVENTION

Aiming to above mentioned disadvantages of prior arts, the present invention proposes to provide a simple, reliable and commercially viable wheel or tire lifter that it easy to use.

In order to arrive at the purposes of the present invention, the wheel/tire lifter according to the invention comprises:

A base, comprising of a base frame and a vertical strut, said base frame being provided with 4 rolling wheels for the base movement;

A drive lift means arranged in said vertical strut;

A driving means to drive said drive lift means; and

A wheel or tire bracket connected with said drive lift means, on which the wheel/tire to be installed is directly placed and secured.

Furthermore, in the said wheel/tire bracket an upward and downward movable press bar is provided in order to further secure the tire placed on the said wheel or tire bracket.

Furthermore, said wheel or tire bracket can move forward and backward connected with the drive lift means to allow retrieval of a wheel tire off a vehicle on a drive on lift/hoist, as is commonly used for wheel alignment.

Said wheel or tire bracket comprises:

Two support bars to support the tire upward;

One horizontal bar with two holes;

Said two support bars respectively pass through said two holes; and

A horizontal pull bar is respectively connected to one end of each of said support bars; thus, in order for the said support bars to move forward and backward if pulled, so that the tire can easily be put away from said support bars.

End of the said press bar is provided with a studded press plate, and said press plate can apply pressure to hold the tire securely in position.

Said press bar may be moved fore and aft horizontally.

Said press bar may be moved upward and downward.

Said vertical strut is provided with a slot longitudinally, and said drive lift means is placed inside said slot.

Said drive lift means can comprise of a screw and a screw rod assembly, and said screw is connected to said wheel or tire bracket, thus, while said screw rod is rotated said screw is moved upward and downward, and said wheel or tire bracket is also moved upward and downward.

Said drive lift means can be a pulley wheel transmission assembly, comprising of a pull rope and a pulley wheel; one end of said pull rope is connected with said pulley wheel, and said pulley wheel is connected with said wheel or tire bracket, so that said pulley wheel will be moved upward and downward to drive said wheel or tire bracket upward and downward movement while said pulley rope is pulled tightly.

Said drive lift means can be a pneumatic mechanism which is connected to said wheel or tire bracket to push said wheel or tire bracket movement upward and downward.

Said drive lift means can also be a hydraulic mechanism which is connected to said wheel or tire bracket to push said wheel or tire bracket movement upward and downward.

The said hydraulic mechanism may be a hydraulic pump.

Said driving means can be an electric motor.

Said driving means can comprise a gear box driven by an electric motor or other means.

Said driving means can comprise a gear box driven by a manual, air powered or electric tool.

Said driving means is driven manually.

According to the wheel or tire lifter provided by the present invention, the tire to be installed can be put or placed on the wheel or tire bracket directly, so said wheel or tire bracket is driven by the said drive lift means and moved upward and downward to a desired height or position, and the tire can easily be moved to the wheel installation position of a car. Even if the tire to be installed is away a certain distance from the position for the tire to be installed, it can be reached or approach by moving the said base or pulling or pushing said pull bar. The invention does not like the prior arts in which the tire is put inside a slot, which needs a special tool (for example, an installation clamp) to take it out and place it. Meanwhile, it is also easy and quick to fit and/or remove wheel/tires from a vehicle. The present invention is a simple structure, which can be used conveniently, and due to its speed of lift and lower is commercially viable for use in modern repair and maintenance workshops.

### BRIEF ON FIGURES

FIG. 1 is a diagrammatic sketch for one embodiment of the present invention.

FIG. 2 is the front view of the embodiment of FIG. 1.

FIG. 3 is a diagrammatic sketch showing that the tire is lifted to a desired height.

### EMBODIMENTS

The specific embodiments are used as follows to describe the present invention. Any auto industry professional can well understand the advantages and benefits of the present invention based on the disclosed contents of the description. The present invention can also be implemented or applied by other means, and details of the present invention can be modified or changed according to different purposes without moving away from the spirit of the invention.

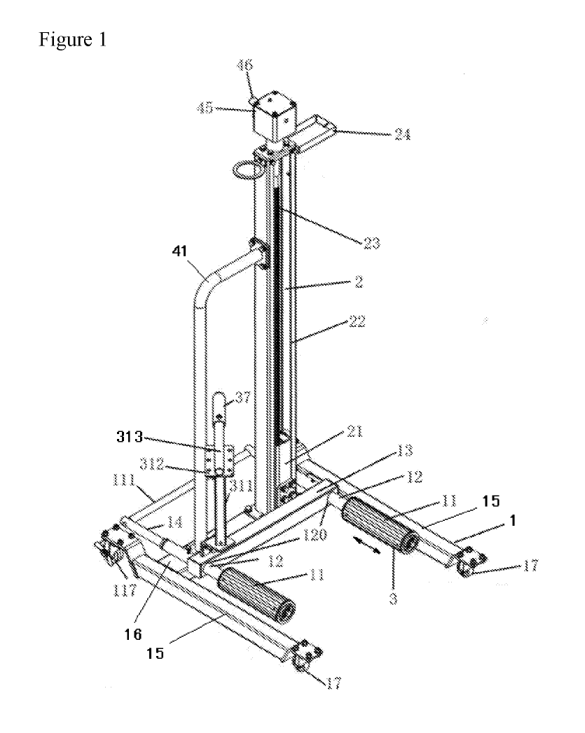

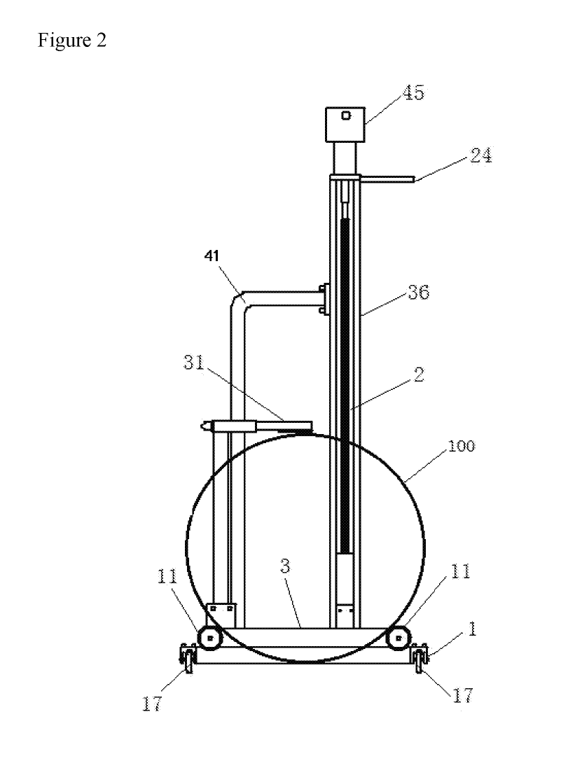

Referring to FIGS. 1 and 2, the present invention provides a wheel or tire lifter for lift and installation of a car wheel or tire, comprising base 1, drive lift means 2 and wheel or tire bracket 3. Base 1 comprises a base frame and vertical strut 36. The base frame, consisting of two parallel base bars 15 and connection bar 16 vertical to said base bars 15, is provided with rolling wheels 17 for movement of base 1 to a desired position. Drive lift means 2 is provided on the vertical strut 36. Wheel or Tire bracket 3 is connected to drive lift means 2, thus, tire 100 to be installed can be put or placed on the wheel or tire bracket 3 (see FIG. 2). One or all of said rolling wheels 17 may be provided with brake 117, in order for the wheel or tire lifter of the present invention can be securely stayed or located at the desired position, and be used safely.

In the embodiment, the wheel/tire bracket 3 comprises of two support bars 11 to support the tire 100 upward (from its lower portion) and horizontal bar 13, and horizontal bar 13 is provided with two holes 120. The extended portion 12 of support bars 11 passes through said hole 120. Horizontal pull bar 111 is respectively connected to end portion 14 of said support bar 11, thus, said support bar 11 can be moved forward and backward if Horizontal pull bar 111 is pulled or pushed (see arrows D and F), so that the tire put on the support bars 11 can easily be taken away from said support bars 11, that is to say, the wheel or tire bracket 3 can move forward and backward relative to drive lift means 2, or, base 1.

Said drive lift means may be a common screw and screw rod assembly, and its screw (not shown in figures) is contained in slide block 21 or directly connected with the slide block 21. Vertical strut 36 is provided with a longitudinal slot 22, and the screw and screw assembly of drive lift means 2 can be placed inside longitudinal slot 22. Longitudinal slot 22 is a long slot whose cross section is a square or rectangle, correspondently, slide block 21's cross section is also a square or rectangle, thus, slide block 21 can slide inside the slot 22 downward and upward, but not rotate.

Slide block 21 is connected to horizontal bar 13 of wheel or tire bracket 3. When screw rod 23 is rotated, slide block 21 containing the said screw is moved upward and downward, thus, to drive wheel or tire bracket 3's up and down movement. Therefore, the tire 100 to be installed or fixed and directly put on the wheel or tire bracket 3 can reach a suitable height so that it can be moved and installed to the car.

Furthermore, in the embodiment the wheel or tire bracket 3 is provided with an upward and downward movable press bar 31 in order to further secure the tire 100 placed on the wheel or tire bracket 3 (see FIG. 2). Referring to FIG. 1, in the embodiment, press bar 31 consists of base bar 311, rotation bar 37 and retractable bar 313. Base 311 is fixed on horizontal bar 13, vertically standing, and rotation bar 37 is a right angle curve bar, and its vertically downward portion covers or traps base bar 311, hereby to be rotated horizontally relative to base bar 311, while its horizontal portion covers or traps retractable bar 313, thus, retractable bar 313 may move horizontally, relative to rotation bar 37.

To more securely put tire 100, support bars 11 of wheel or tire bracket 3 can be coated a layer of soft plastic or rubber (see the dark color portion in FIG. 1), thus, it can cause greater friction force to better secure the tire.

One end of control handle 41 is arranged in or fixed to drive lift means 2, and another end is fixed on the connection bar 16, in order for the user to easily move the total device of the present invention.

In one end of horizontally arranged retractable bar 313 of press bar/tire retainer 31 a press plate 312 is provided, thus, press plate 312 can press tire 100 downward (from above). The lower surface of press plate 312 contacting tire 100 may feature a layer of plastic or rubber skin, protruding spikes/studs or other any frictional surface, thus, that will provide a larger frictional force to secure tire 100 securely.

Drive lift means 2 can be driven by gear box 45, wherein, a driven wheel of gear box 45 is connected to drive lift means 2, and shaft 46 of the driving wheel is exposed outside, thus said shaft may be driven by an electric motor, especially, an electric hand tool (for example, hand drill), or by a handle manually. Of course, Drive lift means 2 may directly be driven manually or by other commonly used electric devices to rotate. Said electric tool driving (electric or rechargeable drill) is a very effective, efficient and convenient in car repair and maintenance and commonly used in today's workshops.

Upper end of vertical strut 36 is provided with handrail 24 to conveniently push and steer the wheel or tire lifter during use.

For the skilled men in the art, on the basis of disclosure of above mentioned embodiments, they can change or modify said elements or parts without any creative activity in arriving at purposes of the present invention:

1. Two support bars 11 of wheel or tire bracket 3 can be replaced by a plain plate, and the back surface of the plate may feature two lower protrusions distanced from each other with a distance less than diameter of the tire. Thus, the tire may be placed between the two protrusions, and is easily moved because the protrusions are lower (for example, its height may be 2-5 cm).

2. Support bar 11, extended portion 12 and end portion 14 can be integrated one bar.

3. Press bar 31 may be omitted.

4. Drive lift means 2 can be a pulley wheel transmission assembly, comprising a pull rope and a pulley wheel; one end of said pull rope is connected with said pulley wheel, and said pulley wheel is connected with said wheel or tire bracket, so that said screw will be moved upward and downward to drive said wheel or tire bracket upward and downward movement while said screw rod is rotated.

5. Said drive lift means can be a pneumatic mechanism or device which is connected said wheel or tire bracket to push said wheel or tire bracket movement upward and downward. The pneumatic mechanism is commonly used, comprising a compressed air source. The pneumatic mechanism may be driven by an outer power supply or self-contained power supply.

6. Said drive lift means can also be a hydraulic transmission mechanism which is connected said wheel or tire bracket to push said wheel or tire bracket movement upward and downward. The said hydraulic mechanism may be a commonly used hydraulic pump. The hydraulic transmission mechanism may be driven by an external power supply or self-contained power supply.

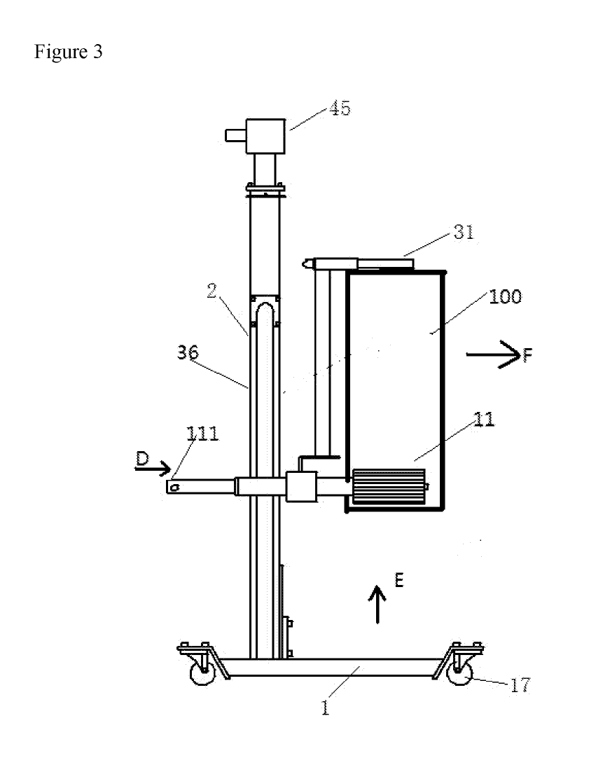

Referring FIGS. 1 to 3, the wheel or tire lifter according to the present invention works as follows:

When it is used, the tire to be installed may vertically be put on the two support bars 11 of tire strut 3. If the tire needs to be secured, press bar 31 can be rotated or pulled to adjust the height or direction of press plate 312 to press the tire 100 downward. Thus, the operator can use an electric tool, for example, an electric or rechargeable hand drill or impact gun, to connect the outer exposed shaft 46 and to drive the driving wheel, thus, the driven wheel of operational gear box 45 drives screw rod 23 of drive lift means, and slide block 21 containing the screw moves upward or downward to reach a suitable or desired height, meanwhile, the base may be moved, or pull bar 111 is pulled or pushed to adjust the distance away from the position point for the tire to be installed. When the distance is very close to the position, the tire is slightly horizontally pushed, and it can be put on the wheel shaft of the car for installation.

For the wheel or tire lifter of the present invention, the wheel or tire to be installed can directly be placed on the wheel or tire bracket, the wheel or tire can directly lifted to reach the desired height or position if the wheel or tire bracket is driven by the drive lift means and moved upward and downward, thus the tire can easily and conveniently be removed or fitted to the car. Even if it is away a distance from the desired installation position, the tire can be slide by moving the base or pulling or pushing the pull bar fore or aft, while in the prior art, the tire is placed inside a slot, it is necessary to use a special tool, for example, a fix clamp to take it out, therefore, the invention's wheel or tire lifter is convenient for fitment and removal of wheel or tire.

Summarizing the above, above description is an embodiment according to the present utility model only, but the protection scope of this utility model is not limited to it, and any skilled men in the field, who are familiar with this field, can think of the change and replace it easily according to contents disclosed by the utility model, therefore, all of them can be covered by the protection scope of the utility model. Therefore, the protection scope should be referred to the extent of protection right of the utility model.

What is claimed:

1. A wheel or tire lifter comprises:
A base, consisting of a base frame and a vertical strut, said base frame being provided with a rolling wheel for the base movement;
A drive lift means arranged in said vertical strut;
A driving means to drive said drive lift means; and
A wheel or tire bracket connected with said drive lift means, on which the tire to be installed is directly placed.

2. The wheel or tire lifter according to the claim 1, wherein in the said wheel or tire bracket an upwards and downwards movable press bar is provided in order to further secure the tire placed on the said wheel or tire bracket.

3. The wheel or tire lifter according to the claim 1, wherein said wheel or tire bracket is easily able to slide the wheel or tire forward and backward enabling the unit to reach in across drive on hoists.

4. The wheel or tire lifter according to the claim 1 or 3, wherein said wheel/tire bracket consists of:
Two support bars to support the tire upward;
One horizontal bar with two holes;
Said two support bars respectively pass through said two holes; and
A horizontal pull bar is respectively connected to one end of each of said support bars; thus, in order for the said support bars to move forward and backward if pulled, so that the tire can easily be put away from said support bars, enabling it to reach in across a higher platform.

5. The wheel or tire lifter according to the claim 2, wherein end of the said press bar is provided with a press plate to press the tire downward.

6. The wheel or tire lifter according to the claim 2, wherein said press bar may be rotated horizontally.

7. The wheel or tire lifter according to the claim 2, wherein said press bar may be moved upward and downward.

8. The wheel or tire lifter according to the claim 1, wherein said vertical strut is provided with a slot longitudinally, and said drive lift means is placed inside said slot.

9. The wheel or tire lifter according to the claim 1, wherein said drive lift means comprises of a screw and a screw rod assembly, and said screw is connected to said wheel or tire bracket, thus, while said screw rod is rotated said screw is moved upward and downward, and said wheel or tire bracket is also moved upward and downward.

10. The wheel or tire lifter according to the claim 1, wherein said drive lift means is a pulley wheel transmission assembly, comprising of a pull rope and a pulley wheel; one end of said pull rope is connected with said pulley wheel, and said pulley wheel is connected with said wheel or tire bracket, so that said pulley wheel will be moved upward and downward to drive said wheel or tire bracket upward and downward movement while said pulley rope is pulled tightly.

11. The wheel or tire lifter according to the claim 1, wherein said drive lift means is a pneumatic mechanism which is connected to said wheel or tire bracket to push said wheel or tire bracket movement upward and downward.

12. The wheel or tire lifter according to the claim 1, wherein said drive lift means can be a hydraulic mechanism which is connected to said wheel or tire bracket to push said wheel/tire bracket movement upward and downward.

13. The wheel or tire lifter according to the claim 1, wherein said driving means can be an electric motor.

14. The wheel or tire lifter according to the claim 1, wherein said driving means can comprise a gear box driven by an electric motor.

15. The wheel or tire lifter according to the claim 1, wherein said driving means can comprise a gear box driven by a manual tool.
